(19) United States
(12) Patent Application Publication
(10) Pub. No.: US 2015/0165362 A1
(43) Pub. Date: Jun. 18, 2015

(54) PLEATED FILTER WITH PLEATPACK TAPERED AT BOTTOM TO MINIMIZE DUST BUILDUP

(71) Applicant: BHA Altair, LLC, Franklin, TN (US)

(72) Inventors: Jeff Allen Canfield, Belton, MO (US); Carl Hemeyer, Slater, MO (US); Jason Mei, East Meadow, NY (US)

(73) Assignee: General Electric Company, Schenectady, NY (US)

(21) Appl. No.: 14/109,111

(22) Filed: Dec. 17, 2013

(51) Int. Cl. B01D 46/52; B01D 46/00

(52) U.S. Cl. CPC B01D 46/521; B01D 46/0001

(57) ABSTRACT

A filter includes a pleated filter material with a plurality of pleats arranged circumferentially. The pleated filter material includes a top half and a bottom half. An end cap is coupled with an axial end of the pleated filter material bottom half, and at least a portion of the pleated filter material is tapered. With a smaller end cap, the filter has less area on which dust can accumulate.

### BACKGROUND OF THE INVENTION

The invention relates to a pleated filter and, more particularly, to a pleated filter that is tapered such that a lower portion of the filter is smaller in diameter than an upper portion of the filter.

Traditional end cap molding forms an end cap 2 with a flat bottom (FIG. 1) that results in a flat bottom disk (FIG. 2). The traditional filter element is susceptible to dust particle accumulation in both static and pulsed applications on the flat ledge 4 between filter pleats. In certain applications, dust build-up on a pleated filter element is undesirable due to the potential for food/pharmaceutical contamination, or dangerous accumulation of combustible dust.

It would be desirable to provide a filter including an end cap with a smaller diameter than a remainder of the filer to reduce the area on which dust can accumulate

### BRIEF DESCRIPTION OF THE INVENTION

In an exemplary embodiment, a filter includes a pleated filter material and an end cap coupled with an axial end of the pleated filter material. The pleated filter material includes a plurality of pleats arranged circumferentially and having a nominal external diameter. The end cap has a diameter that is smaller than the nominal external diameter of the plurality of pleats. The pleated filter material is tapered from the nominal external diameter at a top portion of the pleated filter material to a tapered diameter sized to fit within the end cap diameter.

In another exemplary embodiment, a filter includes a pleated filter material with a plurality of pleats arranged circumferentially. The pleated filter material includes a top half and a bottom half. An end cap is coupled with an axial end of the pleated filter material bottom half, and at least a portion of the bottom half of the pleated filter material is tapered.

In yet another exemplary embodiment, a method of making a filter includes the steps of arranging a pleated filter material circumferentially, the arranged pleated filter material having a nominal external diameter; tapering at least a bottom portion of the arranged pleated filter material such that an external diameter of an axial end of the arranged pleated filter material is smaller than the nominal external diameter; and securing the tapered bottom portion to an end cap at the axial end of the pleated filter material, the end cap having a diameter substantially corresponding to the bottom portion external diameter.

### BRIEF DESCRIPTION OF THE DRAWINGS

FIGS. 1 and 2 show the prior art filter design; and

FIG. 3 is a perspective view of the filter according to preferred embodiments.

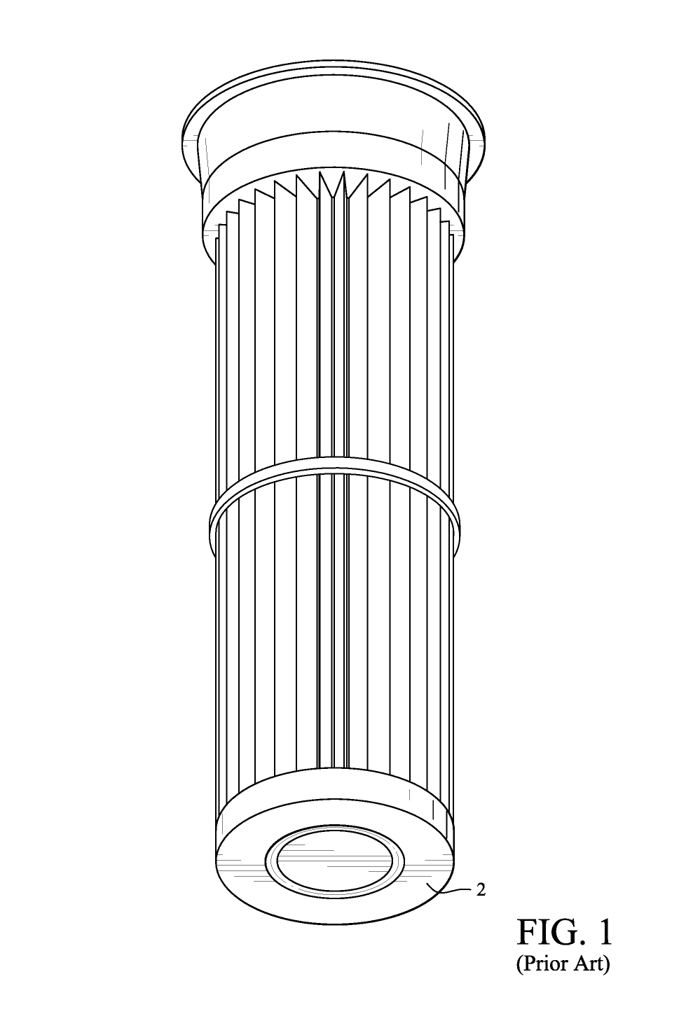

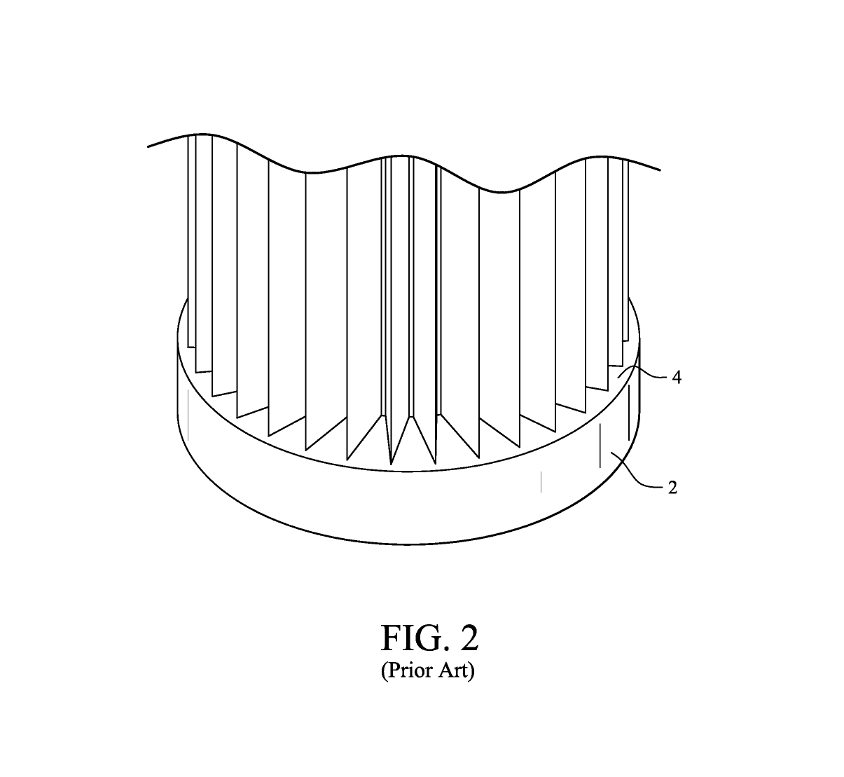

### DETAILED DESCRIPTION OF THE INVENTION

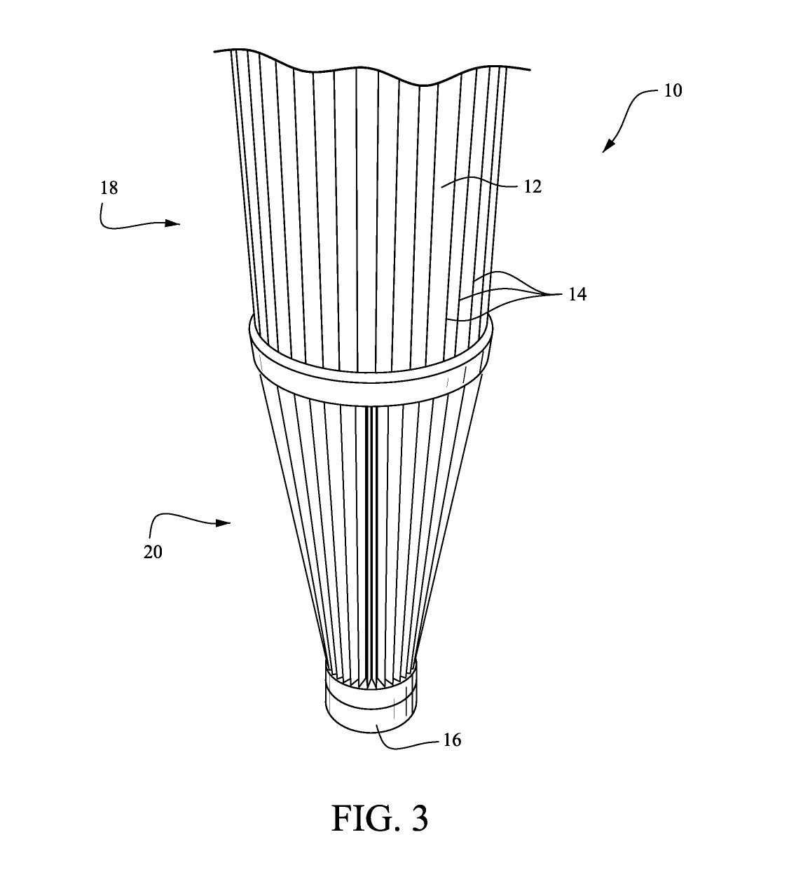

With reference to FIG. 3, a filter 10 includes a pleated filter material 12 including a plurality of pleats 14 arranged circumferentially in a star-shaped pattern. The circumferentially arranged pleats 14 define an inner diameter and an outer diameter. That is, the outer diameter is defined by the outermost peaks of the circumferentially arranged pleats 14, and the inner diameter is defined by the innermost valleys of the pleats 14. In an exemplary construction, each pleat 14 is defined by a rise from the inner diameter to the outer diameter and a fall from the outer diameter to the inner diameter in a V-shape.

An end cap 16 is coupled with an axial end of the pleated filter material 12. The end cap 16 can be formed using any suitable process. In an exemplary process, the end cap is molded using a polymer material. One suitable polymer material is polyurethane. The molded end cap 16 is coupled with the axial end of the pleated filter material 12 during the molding process by embedding the axial end of the filter material 12 during the molding step.

With continued reference to FIG. 3, the end cap 16 has a diameter that is smaller than the nominal external diameter of the circumferentially arranged pleats 14. At least a portion of the pleated filter material 12 is tapered from the nominal external diameter at a top portion of the pleated filter material to a tapered diameter sized to fit within the end cap diameter. In this context, the filter may be divided between a top half 18 and a bottom half 20. In one embodiment, an external diameter of the top half 18 corresponds to the nominal external diameter, and at least a portion of the external diameter of the bottom half 20 is tapered from the nominal external diameter to the tapered diameter. The tapered portion may encompass 5-100% of the filter, preferably 5-50% of the filter, and most preferably 10-15% of the filter. Additionally, the tapered diameter may be about one-half of the nominal external diameter.

In a preferred construction, when the pleated filter material 12 is molded with the end cap 16, the pleated filter material 12 is contracted or bunched to fit within the end cap diameter. In this manner, the pleat spacing is more concentrated at the tapered axial end of the pleated filter material.

With the tapered lower portion and reduced diameter end cap, the filter has less area on which dust can accumulate. That is, a surface area of the end cap will be substantially smaller than that of traditional pleated filters. Moreover, pulse cleaning energy on the lower portion of the pleatpack will be more concentrated due to the tapering the pleatpack, which should give better cleaning of this portion of the filter. The tapered design can also serve to reduce upward velocity between filters (known as “can velocity”) of air/dust flow at the bottom portion of the filter, which will promote better dust fallout and less re-entrainment of dust back on the filter.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A filter comprising:
a pleated filter material including a plurality of pleats arranged circumferentially and having a nominal external diameter; and
an end cap coupled with an axial end of the pleated filter material, the end cap having a diameter that is smaller than the nominal external diameter of the plurality of pleats, wherein the pleated filter material is tapered from the nominal external diameter at a top portion of the pleated filter material to a tapered diameter sized to fit within the end cap diameter.

2. A filter according to claim 1, wherein the pleated filter material comprises a top half and a bottom half, and wherein an external diameter of the top half corresponds to the nominal external diameter, and the external diameter of at least a portion of the bottom half is tapered from the nominal external diameter to the tapered diameter.

3. A filter according to claim 2, wherein the tapered diameter is about one-half of the nominal external diameter.

4. A filter according to claim 1, wherein the tapered diameter is about one-half of the nominal external diameter.

5. A filter according to claim 1, wherein a pleat spacing is more concentrated at the tapered axial end of the pleated filter material.

6. A filter according to claim 1, wherein the taper in the pleated filter material extends across 5-100% of the pleated filter material.

7. A filter according to claim 6, wherein the taper in the pleated filter material extends across 5-50% of the pleated filter material.

8. A filter according to claim 7, wherein the taper in the pleated filter material extends across 10-15% of the pleated filter material.

9. A filter comprising:
a pleated filter material including a plurality of pleats arranged circumferentially, the pleated filter material having a top half and a bottom half;
an end cap coupled with an axial end of the pleated filter material bottom half,
wherein at least a portion of the bottom half of the pleated filter material is tapered.

10. A filter according to claim 9, wherein the portion of the bottom half tapers from a nominal diameter to a smaller diameter at the end cap, and wherein the smaller diameter is about one-half of the nominal diameter.

11. A filter according to claim 10, wherein a pleat spacing is more concentrated at the smaller diameter.

12. A method of making a filter comprising:
arranging a pleated filter material circumferentially, the arranged pleated filter material having a nominal external diameter;
tapering at least a bottom portion of the arranged pleated filter material such that an external diameter of an axial end of the arranged pleated filter material is smaller than the nominal external diameter; and
securing the tapered bottom portion to an end cap at the axial end of the pleated filter material, the end cap having a diameter substantially corresponding to the bottom portion external diameter.

13. A method according to claim 12, wherein the arranged pleated filter material comprises a top half and a bottom half, and wherein the tapering step is practiced by tapering at least a portion of the bottom half of the arranged pleated filter material.

14. A method according claim 13, wherein the tapering step is practiced such that the external diameter of the axial end of the arranged pleated filter material is about one-half of the nominal diameter.

15. A method according to claim 12, wherein the tapering step is practiced such that the external diameter of the axial end of the arranged pleated filter material is about one-half of the nominal diameter.

16. A method according to claim 12, wherein the securing step is practiced by molding the end cap with the axial end of the arranged pleated filter material.

17. A method according to claim 12, wherein the arranged pleated filter material includes a plurality of pleats, and wherein the tapering step is practiced such that a pleat spacing of the plurality of pleats is more concentrated at the tapered axial end of the arranged pleated filter material.
